(19) United States
(12) Patent Application Publication
(10) Pub. No.: US 2022/0398610 A1
(43) Pub. Date: Dec. 15, 2022

(54) METHOD OF FORECASTING STORE DEMAND BASED ON ARTIFICIAL INTELLIGENCE AND SYSTEM THEREFOR

(71) Applicant: TABLEMANGER Inc., Seoul (KR)

(72) Inventor: HoonMin CHOI, Seoul (KR)

(73) Assignee: TABLEMANAGER Inc., Seoul (KR)

(21) Appl. No.: 17/818,213

(22) Filed: Aug. 8, 2022

Related U.S. Application Data
(63) Continuation of application No. PCT/KR2021/000902, filed on Jul. 14, 2021.

(30) Foreign Application Priority Data
Feb. 1, 2021 (KR) 10-2021-0013936

(51) Int. Cl. G06Q 30/02; G06Q 10/02; G06N 3/04

(52) U.S. Cl. CPC G06Q 30/0202; G06Q 10/02; G06N 3/0454

(57) ABSTRACT

A method of operating a system for forecasting store demand may include a step of obtaining existing sales data of a store, including reservation history information and visit history information of customers by date of the store, from a database; a step of preprocessing the existing sales data of the store; a step of generating a plurality of store demand forecasting models using a plurality of preset algorithms that have learned the preprocessed existing sales data of the store; a step of determining a store demand forecasting model based on evaluation results of each of the store demand forecasting models; and a step of forecasting store demand using the determined store demand forecasting model.

### CROSS-REFERENCE TO RELATED APPLICATIONS

This application is a continuation of International Patent Application Number PCT/KR2021/009022 filed Jul. 14, 2021, which claims priority to KR Patent Application Number 10-2021-0013936 filed Feb. 1, 2021, both of which are incorporated herein by reference in their entireties.

### BACKGROUND OF THE DISCLOSURE

### Field of the Disclosure

The present disclosure relates to a method of forecasting store demand, and more particularly, to a method of forecasting store demand based on store visit history and sales history of existing customers using an artificial neural network and a system therefor.

### Description of the Related Art

Of the 660,000 restaurants, there are 569,000 small restaurants with fewer than 5 employees, accounting for 86.5%. Accordingly, most restaurant owners are self-employed, and they do not have a systematic system for store management. Accordingly, these self-employed are vulnerable to fierce competition and rapidly changing environments.

By providing a store manager with scientifically analyzed customer information and sales forecast information, the closure rate of stores run by the self-employed may be reduced. In addition, by providing scientifically analyzed customer information and sales forecast information, the self-employed may effectively respond to external factors for their stores.

Therefore, there is a need for a method of managing store customers by providing scientifically analyzed customer information and sales forecast information. The present disclosure is related to the method.

### SUMMARY OF THE DISCLOSURE

Therefore, the present disclosure has been made in view of the above problems, and it is an object of the present disclosure to provide a method of generating a model for forecasting future store demand based on characteristics for each date and a reservation history for each date and forecasting store demand using the generated system; and a system for forecasting store demand.

The technical problem to be solved by the present disclosure is not limited to the above-mentioned problem, and other problems not mentioned herein can be clearly understood by those skilled in the art from the following description.

In accordance with one aspect of the present disclosure, provided a method of operating a system for forecasting store demand, the method including obtaining existing sales data of a store, including reservation history information and visit history information of customers by date of the store, from a database; preprocessing the existing sales data of the store; generating a plurality of store demand forecasting models using a plurality of preset algorithms that have learned the preprocessed existing sales data of the store; determining a store demand forecasting model based on evaluation results of each of the store demand forecasting models; and forecasting demand at the store using the determined store demand forecasting model.

Here, the method may further include assigning hyperparameters of each of the generated store demand forecasting models to each of the preset algorithms.

Here, the generating of a plurality of store demand forecasting models may include extracting model establishment data from among the existing sales data of the store; generating, by using the preset algorithms, models that have learned the model establishment data; and validating the models using test data that is data excluding the model establishment data among the existing sales data.

Here, the generating of a plurality of store demand forecasting models may further include classifying the existing sales data of the store according to a preset ratio based on label data of each of the existing sales data of the store, and, in the extracting of model establishment data from among the existing sales data of the store, the model establishment data may be extracted from among the existing sales data classified according to the preset ratio.

Here, the generating of a store demand forecasting model may further include inputting each of the reservation history information and the visit history information into a first artificial neural network; inputting the existing sales data of the store excluding the reservation history information and the visit history information into a second artificial neural network; and merging output values of the first artificial neural network and output values of the second artificial neural network, wherein a store demand forecasting model is defined based on the merged output values of the first and second artificial neural networks.

Here, the existing sales data of the store may further include at least one of business type information of the store, size information of the store, and local information of the store.

Here, the method may further include updating the sales data of the store in the database; and examining suitability of the store demand forecasting model by using the updated sales data of the store.

In accordance with another aspect of the present disclosure, provided is a server of a system for forecasting store demand, the server including a memory in which at least one program instruction is stored; a processor for executing the at least one program instruction; and a transceiver that connects to a network and performs communication, wherein the at least one program instruction is executed to obtain existing sales data of a store, including reservation history information and visit history information of customers by date of the store, from a database; preprocess the existing sales data of the store; generate a plurality of store demand forecasting models using a plurality of preset algorithms that have learned the preprocessed existing sales data of the store; determine a store demand forecasting model based on evaluation results of each of the store demand forecasting models; and forecast demand at the store using the determined store demand forecasting model.

Here, the at least one program instruction may be further executed to assign hyperparameters of each of the generated store demand forecasting models to each of the preset algorithms.

Here, when the at least one program instruction is executed to generate the store demand forecasting models, the at least one program instruction may be executed to extract model establishment data from among the existing sales data of the store; generate, using the preset algorithms, models that have learned the model establishment data; and validate the models using test data that is data excluding the model establishment data among the existing sales data.

Here, when the at least one program instruction is executed to generate the store demand forecasting models, the at least one program instruction may be further executed to classify the existing sales data of the store according to a preset ratio based on label data of each of the existing sales data of the store, and when the at least one program instruction is executed to extract model establishment data from among the existing sales data of the store, the model establishment data may be extracted from among the existing sales data classified according to a preset ratio.

Here, when the at least one program instruction is executed to generate the store demand forecasting model, the at least one program instruction may be further executed to input each of the reservation history information and the visit history information into a first artificial neural network; input the existing sales data of the store excluding the reservation history information and the visit history information into a second artificial neural network; and merge output values of the first artificial neural network and output values of the second artificial neural network, wherein a store demand forecasting model is defined based on the merged output values of the first and second artificial neural networks.

Here, the existing sales data of the store may further include at least one of business type information of the store, size information of the store, and local information of the store.

Here, the at least one program instruction may be further executed to update the sales data of the store to the database; and examine suitability of the store demand forecasting model using the updated sales data of the store.

Aspects of the present disclosure described above are only some of the preferred embodiments of the present disclosure. Based on the detailed description of the present disclosure to be described below, various embodiments reflecting the technical features of the present disclosure may be derived and understood by those of ordinary skill in the art.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a conceptual diagram showing an embodiment of the configuration of a system for forecasting store demand;

FIG. 2 is a block diagram showing an embodiment of the configuration of a device constituting a system for forecasting store demand;

FIG. 3 is a conceptual diagram showing an embodiment of an artificial neural network included in the device of a system for forecasting store demand;

FIG. 4 is a conceptual diagram showing an embodiment of the artificial intelligence architecture of a system for forecasting store demand;

FIG. 5 is a flowchart for explaining an embodiment of a method of forecasting store demand using a system for forecasting store demand;

FIG. 6 is a flowchart for explaining an embodiment of a method of generating a demand forecasting model using model establishment data and test data of a system for forecasting store demand;

FIG. 7 is a flowchart for explaining an embodiment of a method of generating a store demand forecasting model using a system for forecasting store demand; and

FIG. 8 shows an embodiment of a method of evaluating a store demand forecasting model using a system for forecasting store demand.

### DETAILED DESCRIPTION OF THE DISCLOSURE

Since the present disclosure may be applied with various modifications and may have various embodiments, exemplary embodiments and drawings of the present disclosure are intended to be explained and exemplified. However, these exemplary embodiments and drawings are not intended to limit the embodiments of the present disclosure to particular modes of practice, and all changes, equivalents, and substitutes that do not depart from the spirit and technical scope of the present disclosure should be understood as being encompassed in the present disclosure.

The terms such as “first” and “second” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the teachings of the present disclosure. The term “and/or” includes any or all combinations of one or more of the associated listed items.

It should be understood that when an element is referred to as being “connected to” or “coupled to” another element, the element may be directly connected or coupled to the other element or intervening elements may be present. In contrast, when an element is referred to as being “directly connected to” or “directly coupled to” another element, there are no intervening elements present.

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present disclosure will be described in detail with reference to the accompanying drawings. In describing the present disclosure, to facilitate the overall understanding, the same reference numerals are used for the same components in the drawings, and repeated descriptions of the same components are omitted.

A system for forecasting store demand to which embodiments according to the present disclosure are applied will be described. The system for forecasting store demand to which embodiments according to the present disclosure are applied is not limited to the description below, and embodiments according to the present disclosure may be applied to various communication systems.

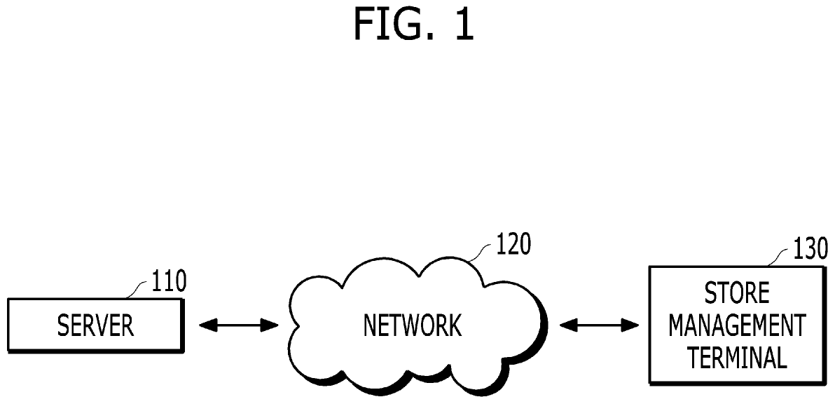

FIG. 1 is a conceptual diagram showing an embodiment of the configuration of a system for forecasting store demand.

Referring to FIG. 1, the system for forecasting store demand may include a store demand forecasting server 110 for managing customers of each store and forecasting store demand and a store management terminal 130 connected to the store demand forecasting server 110 through a network 120.

The store demand forecasting server 110 may store information necessary to manage customer-related information such as store visit history information of customers of each store and store sales history information and provide a service for forecasting store demand. The store demand forecasting server 110 may store information including an algorithm for generating a customer demand forecasting model for a store and a store demand forecasting model in advance.

The network 120 may mean a connection structure for exchanging information between the store demand forecasting server 110 and the store management terminal 130. The network 120 may include Internet, a local area network (LAN), a wireless local area network (wireless LAN), a wide area network (WAN), a personal area network (PAN), 3G, 4G, long term evolution (LTE), voice over LTE (VoLTE), 5G new radio (NR) wireless-fidelity (Wi-Fi), Bluetooth, NFC, a radio frequency identification (RFID) home network, Internet of things (IoT), and the like.

The store management terminal 130 may be connected to the store demand forecasting server 110 through the network 120. In addition, the store management terminal 130 may include user equipment such as computers, tablets, and smartphones. The store management terminal 130 may receive information provided through a service for customer management from the store demand forecasting server 110. The information received from the store demand forecasting server 110 may include result data for store demand forecast, and the like.

The store management terminal 130 may display the received result data for store demand forecast through an output device. In addition, the store management terminal 130 perform feedback on a service provided from the store demand forecasting server 110 based on information input by a user.

The store demand forecasting server 110 and the store management terminal 130 of FIG. 1 may be referred to as devices, and the configurations thereof are described below.

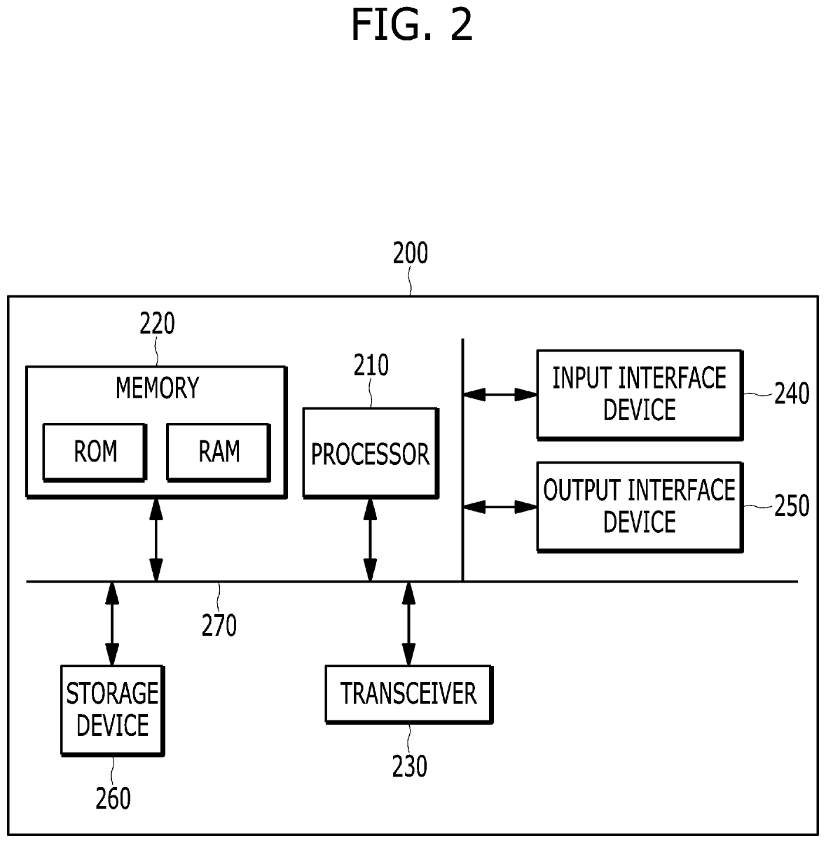

FIG. 2 is a block diagram showing an embodiment of the configuration of a device constituting a system for forecasting store demand.

A device 200 included in the store demand forecasting server may at least one processor 210 and a memory 220 for storing instructions instructing the processor 210 to perform at least one step.

Here, the processor 210 may mean a central processing unit (CPU), a graphics processing unit (GPU), or a dedicated processor for performing methods according to embodiments of the present disclosure. Each of the memory 220 and a storage device 260 may be configured as at least one of a volatile storage medium and a non-volatile storage medium. For example, the memory 220 may be configured as at least one of read only memory (ROM) and random access memory (RAM).

In addition, the device 200 included in the store demand forecasting server may include a transceiver 230 that performs communication through a wireless network. In addition, the device 200 included in the store demand forecasting server may further include an input interface device 240, an output interface device 250, and the storage device 260. The components included in the device 200 included in the store demand forecasting server may be connected by a bus 270 to communicate with each other.

In addition, the device 200 included in the store demand forecasting server may further include hardware components or software components for implementing/driving an artificial neural network. For example, the hardware components may include a neural processer unit (NPU), and the like. For example, the software components may include a framework, a kernel or device driver, a middleware, an application programming interface (API), an application program (or application), and the like. The artificial neural network implemented by the device is described below.

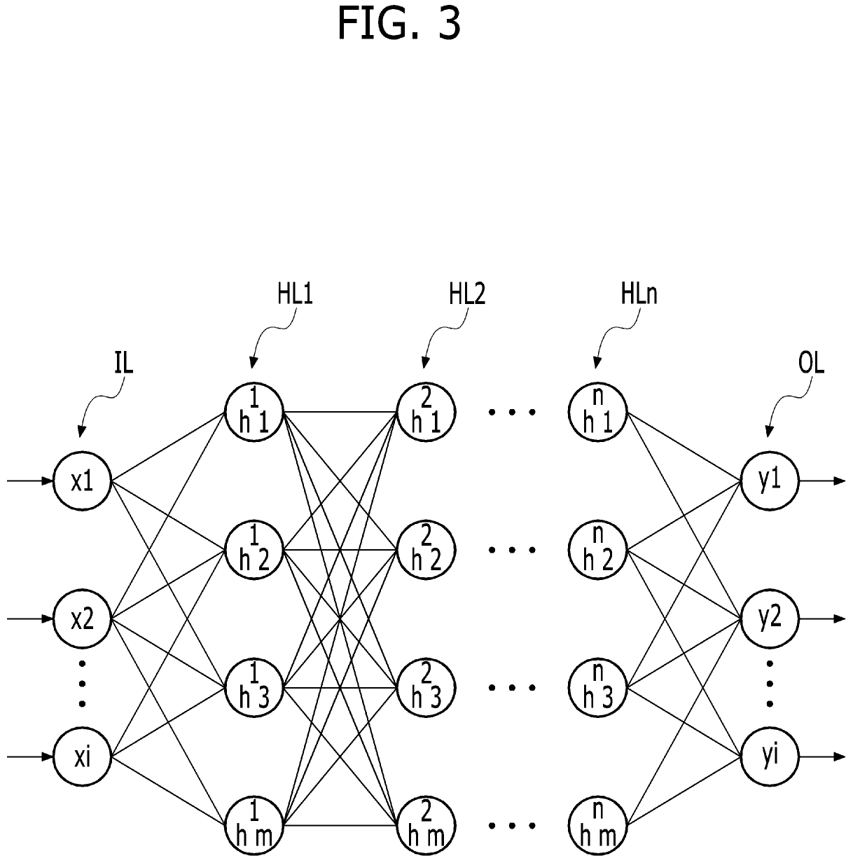

FIG. 3 is a conceptual diagram showing an embodiment of an artificial neural network included in the device of a system for forecasting store demand.

Referring to FIG. 3, the artificial neural network may include an input layer (IL), a plurality of hidden layers (HL1, HL2, . . . , HLn), and an output layer (OL).

The input layer (IL) may include i (i being a natural number) input nodes (x1, x2, . . . , xi). In addition, vector input data having a length of i may be input to the input node.

The hidden layers (HL1, HL2, HLn) may include n (n being a natural number) hidden layers and may include hidden nodes (h11, h12, h13, . . . , h1m, h21, h22, h23, . . . , h2m, hn1, hn2, hn3, . . . . hnm). For example, the hidden layer (HL1) may include m (m being a natural number) hidden nodes (h11, h12, h13, . . . , h1m), the hidden layer (HL2) may include m hidden nodes (h21, h22, h23, . . . , h2m), and the hidden layer (HLn) may include m hidden nodes (hn1, hn2, hn3, . . . , hnm).

The output layer (OL) may include j (j being a natural number) output nodes (y1, y2, . . . yj) corresponding to classes to be classified and may output a result (for example, a score or a class score) for each class with respect to input data. The output layer (OL) may be referred to as a fully connected layer.

The artificial neural network shown in FIG. 3 may include a branch between nodes shown as a straight line between two nodes and weight values between the connected nodes. Here, nodes in one layer may not be connected to each other, and nodes included in different layers may be completely or partially connected.

Each node (for example, h11) of FIG. 3 may receive the output of a previous node (for example, x1) and perform an operation, and may transmit the operation result to a subsequent node (for example, h21). Here, each of the nodes may calculate a value to be output by applying an input value to a specific function (for example, a nonlinear function).

In general, the structure of an artificial neural network is predetermined, and weights according to connection between nodes may be appropriately calculated using data to which a class to belong is predetermined. Data for which the correct answer is already known may be referred to as “learning data”, and a process of determining a weight may be referred to as “learning”. In addition, a set of independently learnable structures and weights may be referred to as a “model”.

That is, a device such as a server shown in FIG. 2 may use the artificial neural network shown in FIG. 3 to perform operations supported by the system. Algorithms and operations executed by the server and the store management terminals included in a system for forecasting store demand are described below.

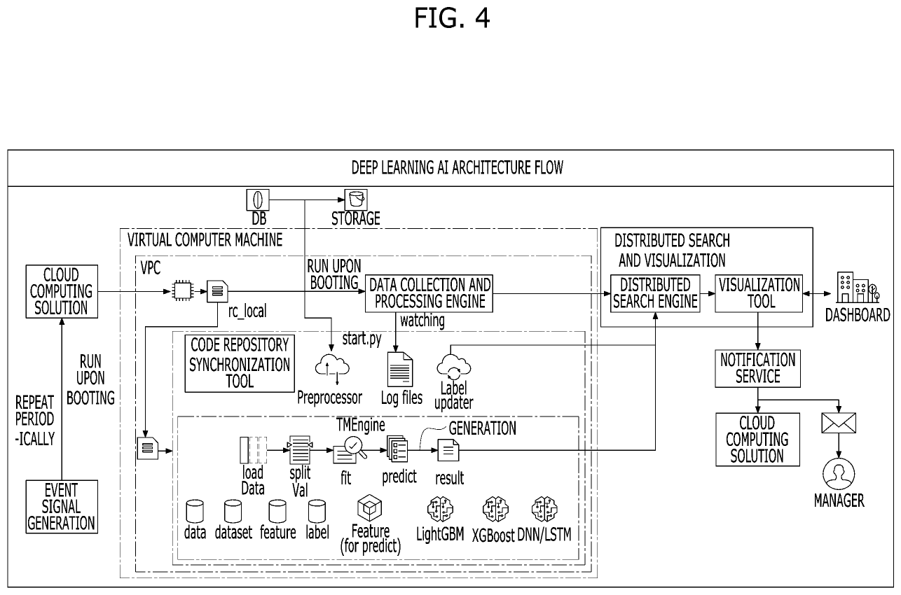

FIG. 4 is a conceptual diagram showing an embodiment of the artificial intelligence architecture of a system for forecasting store demand.

Referring to FIG. 4, the artificial intelligence architecture of the system for forecasting store demand may include cloud computing solution, a virtual computing machine including virtual private cloud (VPC), a database, a data collection and processing engine, and the like. The components of the artificial intelligence architecture of the system for forecasting store demand and operations of each component are described below.

An event signal generator of the artificial intelligence architecture generates a signal at a specified time, and specifically, calls cloud computing solution at a specified time (for example, 7:00 AM) every day. The cloud computing solution may function as an instance-controller.

The cloud computing solution may boot a virtual computing machine. Here, the virtual computing machine is a computing machine running on a cloud, and may be a computing machine such as an EC2 instance. The virtual computing machine executes a registered startup program. Specifically, the virtual computing machine executes an engine startup script (start.py) among executable shell script files (start.sh). Options for the engine startup script are described below.

Updated: When there is no option in an engine startup script, a virtual computing machine updates the code of the engine startup script to the latest version, gives an updated option, and then executes the engine startup script again. When running the engine startup script for the first time, the updated option may not be given to the engine startup script.

Preprocess: When a preprocessing option is given to an engine startup script, a virtual computing machine retrieves data up to the previous day required for training from a repository for temporary weather data and other engine data and a database for reservation and store data and performs a preprocessing operation to convert the imported data into a form that may be processed into learning data.

Model_type=LightGBM|XGBoost|Dense: A virtual computing machine selects a model to train with a machine learning engine (for example, TMEngine) based on a model type option given to an engine startup script.

Label: After training, a virtual computing machine updates the previous label data stored in a prediction result data store, such as a data collection and processing engine, and gives a label option to an engine startup script. Typically, the last script executed is given a label option.

Forced start: When a forced start option is given to an engine startup script, a virtual computing machine may execute the engine startup script even after a preset holding time (for example, MAINTENANCE_TIME) has elapsed.

Shutdown: When a shutdown option is given to an engine startup script, a virtual computing machine is shut down after training ends. Typically, the last executed script is given a shutdown option.

Not_update: When a not_update option is given to an engine startup script, a virtual computing machine may not upload data generated as a prediction result to a data collection and processing engine after training is finished.

An engine startup script (start.py) runs a machine learning engine (for example, TMEngine). The machine learning engine performs data learning.

By performing a preprocessing operation, the machine learning engine may update learning data and convert the learning data into a data set in a form usable in the Python environment. The machine learning engine may generate input data and label data that are learning data based on the transformed data set.

The machine learning engine may classify data for validation among learning data. Specifically, the machine learning engine divides the learning data into training data and verification data, and in general, the ratio of the training data and the verification data may be 9:1. Here, for proper evaluation in a model learning process, it is preferable that the data configurations of the training data and the validation data are similar to each other. The machine learning engine analyzes the statistical distribution of label data, reflects the analysis result, and finds the point where the label data is split at a specific ratio based on a specific value.

The machine learning engine defines and learns a model. The type of algorithm constituting the model may vary depending on execution options. Here, the algorithm constituting the model may include an XGBoost algorithm, a LightGBM algorithm, and a deep learning algorithm. In addition, the deep learning algorithm may include a deep neural network (DNN)-based algorithm, a convolutional neural network (CNN)-based algorithm, a recurrent neural network (RNN)-based algorithm, a long short-term memory (LSTM)-based algorithm, and the like.

The machine learning engine generates prediction values based on input data for prediction prepared in advance through a model. The machine learning engine stores model information, prediction settings, prediction target input data, prediction values, and the like.

The virtual computing machine stores prediction result data in a distributed search engine. In addition, the virtual computing machine may visualize the prediction result data and/or an engine log by linking the prediction result data to a visualization tool and may output the analysis result of the prediction result data and/or the engine log.

The virtual computing machine may analyze the engine log and detect whether a system failure has occurred based on the analysis result of the engine log. When occurrence of a system failure is detected, the virtual computing machine sends a message through a service that generates a notification signal with reference to data stored in a distributed search engine. An administrator may request the progress of the corresponding action based on the received message.

The method of forecasting store demand using a system for forecasting store demand including a virtual computing machine is described below.

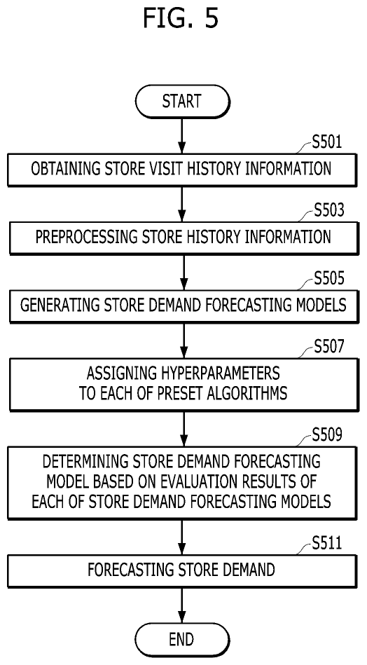

FIG. 5 is a flowchart for explaining an embodiment of a method of forecasting store demand using a system for forecasting store demand.

In step S501, the server may obtain existing sales data of a store including reservation history information and visit history information of customers by date of the store from a database. The existing sales data may be input data for forecasting store demand. The existing sales data of a store may include information on characteristics for each date, and the information on characteristics for each date may include date, weather, and holidays

In step S503, the server may preprocess each piece of information of existing sales data of a store. The server may preprocess each piece of information according to a predefined criterion according to the characteristics of each piece of information, and each piece of information may be preprocessed as follows.

Date data may be preprocessed to indicate the year, month, day, and day of the week, and may be preprocessed to indicate whether it is a weekend or a holiday. Weather data may be preprocessed to indicate the season, temperature, rainfall, and the like on a specific day.

Reservation data may include customer's store visit reservation information, and the server may perform preprocessing so that the customer's store visit reservation information is divided into predetermined time period units (for example, weekly units). For example, the server may classify reservations into reservations made 34 to 28 days ago, reservations made 27 to 21 days ago, reservations made 20 to 14 days ago, reservations made 13 to 7 days ago, and reservations made on the same day.

The server may preprocess existing sales data of a store to indicate the size of the store. The server may calculate the average number of daily reservations for a certain long-term period (for example, 3 months) before a prediction time and the average number of daily reservations for a certain short-term period (for example, 1 month) before the prediction time. In addition, the server may preprocess the existing sales data of the store by calculating the average number of visitors for a month before the prediction time.

In addition, the server may preprocess existing sales data of a store by calculating the number of orders and the number of tables in the store. In addition, in addition to the size information of the store, the server may preprocess the existing sales data of the store to indicate information on the type of business and/or region information.

The server may preprocess existing sales data of a store to indicate the tendency of customers to visit the store. The server may calculate a walk-in ratio based on the total number of reservations in the store and the number of walk-in reservations. In addition, the server may preprocess the existing sales data of the store by classifying the total reservation information of the store by day of the week and calculating the number of reservations for each day of the week.

In step S505, the server may learn each piece of information of existing sales data of a store preprocessed using a plurality of preset algorithms and generate a plurality of store demand forecasting models. The existing sales data of a store may be divided into training data for model learning and test data for model evaluation according to usage in the process of generating and evaluating a demand forecasting model. In addition, the training data may be divided into model establishment data, which is data for establishing a model, and verification data for verifying the suitability of the model.

The server may learn at least some of the existing sales data of a store (for example, model establishment data) by using a plurality of different algorithms and may use other data (for example, verification data) to judge suitability of learning results. Here, a method of extracting model establishment data used to perform learning among existing sales data and a method of performing learning using the extracted model establishment data are described below.

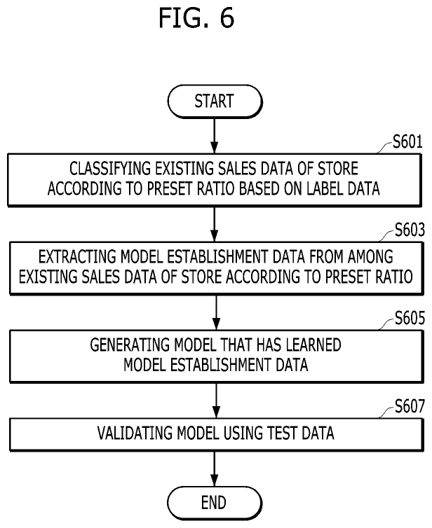

FIG. 6 is a flowchart for explaining an embodiment of a method of generating a demand forecasting model using model establishment data and test data of a system for forecasting store demand.

In step S601, the server may classify existing sales data of a store according to a preset ratio based on label data. Specifically, the server may classify the training data according to a preset ratio based on the label data of each training data among the existing sales data of a store. Here, the label data may indicate the number of reservations for a store per day. That is, the server may analyze the distribution of the label data and classify the existing sales data of the store based on the distribution.

For example, when a sample having label data of 20 or less is 80% and a sample having label data greater than 20 is 20%, the server may classify existing sales data of a store into two groups based on the label data. Here, the first group may be a data group including label data of 20 or less, and the second group may be a data group including label data of more than 20.

In step S603, the server may extract model establishment data from existing sales data of a store according to a preset ratio. For example, the server may extract 80% of the model establishment data of a store from the first group and extract 20% thereof from the second group. In addition, the existing sales data excluding the model establishment data may be validation data. Accordingly, the server may set the label distribution of model establishment data and validation data similarly.

In step S605, the server may generate a model that has learned model establishment data from among existing sales data of a store. The server may generate a plurality of demand forecasting models by learning model establishment data using different algorithms. Here, the algorithms may include an XGBoost algorithm, a LightGBM algorithm, a deep learning algorithm, a linear regression algorithm, a support vector machine (SVM) algorithm, a decision tree algorithm, and a random forest algorithm. In addition, the deep learning algorithm may include a DNN-based deep learning algorithm, a CNN-based algorithm, and an LSTM-based algorithm.

The server generates a plurality of demand forecasting models and calculates an average of the forecasted values of the models, thereby improving the accuracy of a forecasted value. Alternatively, the server may improve the accuracy of a forecasted value by comparing the accuracy of each of a plurality of demand forecasting models and calculating a forecasted value using one model having the highest accuracy.

In step S607, the server may validate a generated demand forecasting model by using validation data other than model establishment data among existing sales data of a store. Here, the server may validate the suitability of a demand forecasting model by using the K-fold cross validation algorithm. The server may calculate the accuracy of a generated demand forecasting model as a result of validation using validation data.

In learning model establishment data and generating a demand forecasting model, the server may generate one demand forecasting model using a plurality of models. Operation of generating a store demand forecasting model, which is one of a plurality of models, by the server will be described below.

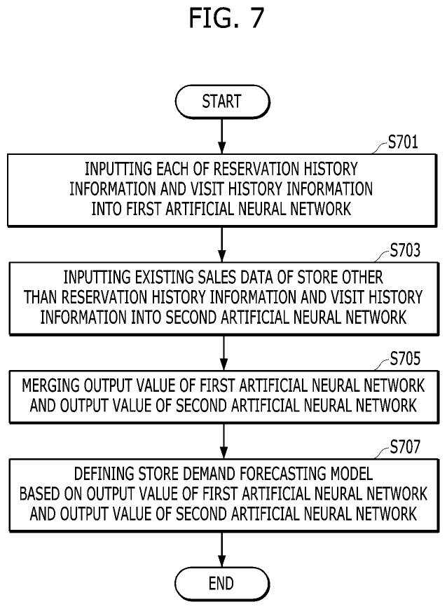

FIG. 7 is a flowchart for explaining an embodiment of a method of generating a store demand forecasting model using a system for forecasting store demand.

The server may perform learning based on existing sales data of a store including at least one of reservation history information, visit history information, date information, weather information, store size information, information on the type of business, and/or local information. In particular, the server may generate a store demand forecasting model by learning model establishment data that is a part of training data among existing sales data of a store.

In step S701, the server may input reservation history information and visit history information in the first artificial neural network. The server may input information on the number of daily reservations among reservation history information into the first artificial neural network, and may input information on the number of visitors among visit history information into the first artificial neural network. Here, the first artificial neural network may be an artificial neural network based on one of CNN, DNN, and RNN.

For example, when the first artificial neural network is an CNN-based artificial neural network, the server may receive information on the number of daily reservations, perform a one-dimensional convolution operation, and input a value calculated as a result of performing the convolution operation to an activation function to calculate a final output value. Here, the activation function may be at least one of a MaxPooling function, a Softmax function, and a ReLu function.

In step S703, the server may input existing sales data of a store other than reservation history information and visit history information into the second artificial neural network. Here, the existing sales data of a store other than reservation history information and visit history information may include at least one of date information, weather information, store size information including the number of orders and tables in a store, and the business field and region information of a store. In addition, the second artificial neural network may be one of DNN, CNN, and RNN. In addition, the second artificial neural network may be an artificial neural network separate from the first artificial neural network, but the present disclosure is not limited thereto.

For example, when the second artificial neural network is a DNN-based artificial neural network, the server may input date-related data and time-related data to a dense layer and input an output value of the dense layer to an activation function to calculate a final output value. Here, the activation function may be at least one of a MaxPooling function, a Softmax function, and a ReLu function.

In step S705, the server may merge the output value of the first artificial neural network and the output value of the second artificial neural network. That is, the server may merge information of at least a portion of information on the number of reservations, information on the number of visitors, date information, weather information, store size information, information on the type of business, and/or local information output as a result of input to each of artificial neural networks. Data generated as a result of merging information of at least a portion of information on the number of reservations, information on the number of visitors, date information, weather information, store size information, information on the type of business, and/or local information is referred to as merged data.

In step S707, the server may define a store demand forecasting model based on the output value of the first artificial neural network and the output value of the second artificial neural network. The server may define a store demand forecasting model based on merged data by inputting the merged data into an artificial neural network-based model.

Here, the artificial neural network may be one of DNN, CNN, and RNN. For example, when the second artificial neural network is a DNN-based artificial neural network, the store demand forecasting model may input merged data input to a dense layer and input the output value of the dense layer to an activation function to calculate a final output value. Here, the activation function may be at least one of a MaxPooling function, a Softmax function, and a ReLu function.

The server may train a store demand forecasting model with existing sales data of a store including one or more pieces of information. In addition, the server may forecast store demand by using the learned store demand forecasting model.

Referring to FIG. 5, in step S507, the server may assign a hyperparameter setpoint to each of a plurality of algorithms used to generate each of a plurality of store demand forecasting models. The hyperparameter refers to a variable that is a learning criterion in a model, and may include at least one of the number of hidden layers, the number of nodes, activation functions, optimization methods, the number of tests (epoch), batches, and dropout. The server may assign the setpoints of optimal hyperparameters predefined to generate a model to algorithms. In addition, the server may store the setpoints of each hyperparameter in algorithms for generating a model on one library. Accordingly, the server may easily switch between a plurality of algorithms when performing a learning operation.

In step S509, the server may evaluate each of a plurality of store demand forecasting models and may determine a store demand forecasting model based on the evaluation results. Specifically, the server may calculate evaluation indexes of each of a plurality of store demand forecasting models by using test data excluding training data among existing data of a store. The operation of the server of calculating evaluation indexes for evaluating each of a plurality of store demand forecasting models and the operation of the server of evaluating each of a plurality of store demand forecasting models based on evaluation indexes are described below.

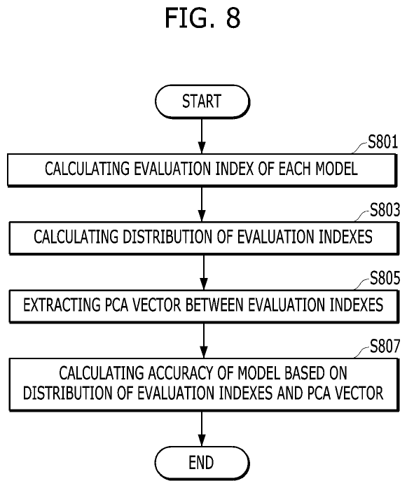

FIG. 8 shows an embodiment of a method of evaluating a store demand forecasting model using a system for forecasting store demand.

The server may evaluate a store demand forecasting model using existing sales data of a store including at least one of reservation history information, visit history information, date information, weather information, store size information, information on the type of business, and/or local information. In particular, the server may calculate a forecasted value by inputting test data among existing sales data of a store into a store demand forecasting model, and may evaluate the store demand forecasting model based on the comparison result between the calculated forecasted value and actual label data.

In step S801, the server may calculate the evaluation indexes of each of store demand forecasting models. The evaluation indexes may be calculated based on the error values of store demand forecasting models. The evaluation indexes may include a mean absolute error (MAE) and a mean absolute percentage error (MAPE).

The server may calculate the MAE of a store demand forecasting model by performing the operation of Equation 1.

$$MAE = \frac{{\sum }_{i = 1}^{n} \vert {y}_{i} - {x}_{i} \vert}{n} = \frac{{\sum }_{i = 1}^{n} \vert {e}_{i} \vert}{n} \qquad [ Equation 1 ]$$

In Equation 1, yi denotes the forecasted value of store demand through a model, xi denotes the label data value of the test data of a store, and n denotes the total number of test data.

In addition, the server may calculate the MAPE of a store demand forecasting model by performing the operation of Equation 2.

$$MAPE = \frac{1}{n} {\sum }_{t = 1}^{n} \vert \frac{{A}_{t} - {F}_{t}}{{A}_{t}} \vert \qquad [ Equation 2 ]$$

In Equation 2, Aₜ denotes an actual store demand value, Fₜ denotes the forecasted value of store demand through a model, and n denotes the total number of test data.

In step S803, the server may calculate distribution of evaluation indexes of each of store demand forecasting models. The server may calculate a bivariate normal distribution between max_average percentage error (APE) and MAPE based on max_APE and MAPE, which are the maximum values of the average error rates of each of forecasted data. Accordingly, the server may calculate the two-dimensional normal distribution of max_APE and MAPE. In calculating the normal distribution of max_APE and MAPE, the server may calculate the two-dimensional normal distribution of max_APE and MAPE by further reflecting at least one of MAE, Pearson's coefficient, and SSE.

In step S805, the serve may extract a principal component analysis (PCA) vector between the evaluation indexes of each of store demand forecasting models. The server may extract a PCA vector based on the two-dimensional normal distribution of max_APE and MAPE.

In step S807, the server may calculate the accuracy of a store demand forecasting model based on distribution of the evaluation indexes of each of store demand forecasting models and the PCA vector. The server may calculate the distribution of max_APE and MAPE. Here, the calculated distribution may be the distribution of the Euclidean distances of max_APE and MAPE. The server may evaluate stability, accuracy, and/or reliability by a store demand forecasting model based on at least one of asymmetry, mean, median, and standard deviation of the calculated distribution. In addition, the server may evaluate stability by a demand forecasting model based on the magnitude and direction of the PCA vector.

Referring to FIG. 5, in step S509, the server may forecast store demand by using the determined store demand forecasting model. The server may obtain input data for forecasting store demand from a database, and may forecast store demand by inputting the obtained input data into the determined store demand forecasting model.

The server may periodically update the sales data of a store to a database. In addition, the server may continuously check the suitability of a store demand forecasting model by using the updated store sales data. When an accuracy greater than or equal to a preset value is calculated using an updated sales data of a store, the server may maintain a store demand forecasting model. On the other hand, as a result of a test using the updated store sales data, when an accuracy less than a preset value is calculated using the updated store sales data, the server may adjust the hyperparameter of a store demand forecasting model.

According to one embodiment, the server may execute an operation of forecasting store demand at a specific time. The server may forecast store demand at a predetermined time and store the forecast results. Here, the predetermined time may be a time before the start time of the store. The administrator of the server may check the forecast results calculated by the server. When the forecast results are normal, the forecast result data may be provided to the manager terminal of the store. Accordingly, the server may reduce time required to obtain an input value and time required to forecast a model.

According to an embodiment of the present disclosure, a system for forecasting store demand can provide scientifically forecasted customer information and sales forecast information by forecasting future store demand based on characteristics for each date and a reservation history for each date.

According to an embodiment of the present disclosure, the system for forecasting store demand can provide customer analysis information and sales forecast information using an accurate demand forecasting model by generating a plurality of store demand forecasting models using a plurality of algorithms and evaluating each of the generated store demand forecasting models.

Effects obtainable through the present disclosure are not limited to the aforementioned effects, and other effects not mentioned will be clearly understood by those of ordinary skill in the art to which the present disclosure pertains from the description below.

The methods according to the embodiments of the present disclosure may be implemented in the form of a program command that can be executed through various computer means and recorded in a computer-readable medium. The computer-readable medium can store program commands, data files, data structures or combinations thereof. The program commands recorded in the medium may be specially designed and configured for the present disclosure or be known to those skilled in the field of computer software.

Examples of a computer-readable recording medium include hardware devices such as ROMs, RAMs, and flash memories, which are specially configured to store and execute program commands. Examples of the program commands include machine language code generated by a compiler and high-level language code executable by a computer using an interpreter and the like. The hardware devices described above may be configured to operate as one or more software modules to perform the operations of the embodiments, and vice versa.

Although the present disclosure has been described above with reference to the embodiments of the present disclosure, those skilled in the art may variously modify and change the present disclosure without departing from the spirit and scope of the present disclosure as set forth in the claims below.

We claim:

1. A method of operating a system for forecasting store demand, comprising:
obtaining existing sales data of a store from a database, wherein the sales data comprises reservation history information and visit history information of customers by date of the store;
preprocessing the existing sales data of the store;
generating a plurality of store demand forecasting models using a plurality of preset algorithms that have learned the preprocessed existing sales data of the store;
determining a store demand forecasting model based on evaluation results of each of the store demand forecasting models; and
forecasting demand at the store using the determined store demand forecasting model.

2. The method according to claim 1, further comprising assigning hyperparameters of each of the generated store demand forecasting models to each of the preset algorithms.

3. The method according to claim 1, wherein the generating of a plurality of store demand forecasting models comprises extracting model establishment data from among the existing sales data of the store;
generating models that have learned the model establishment data, wherein the generating of models comprises using the preset algorithms; and
validating the models using validation data that is data excluding the model establishment data among the existing sales data.

4. The method according to claim 3, wherein the generating of a plurality of store demand forecasting models further comprises classifying the existing sales data of the store according to a preset ratio based on label data of each of the existing sales data of the store, and
wherein the extracting of model establishment data from among the existing sales data of the store comprises extracting the model establishment data from among the existing sales data classified according to the preset ratio.

5. The method according to claim 1, wherein the generating of a store demand forecasting model further comprises inputting each of the reservation history information and the visit history information into a first artificial neural network;
inputting the existing sales data of the store excluding the reservation history information and the visit history information into a second artificial neural network; and
merging output values of the first artificial neural network and output values of the second artificial neural network,
wherein the store demand forecasting model is defined based on the merged output values of the first and second artificial neural networks.

6. The method according to claim 1, wherein the existing sales data of the store further comprise at least one of business type information of the store, size information of the store, and local information of the store.

7. The method according to claim 1, further comprising updating the sales data of the store in the database; and
examining suitability of the store demand forecasting model by using the updated sales data of the store.

8. A server of a system for forecasting store demand, comprising:
a memory in which at least one program instruction is stored;
a processor for executing the at least one program instruction; and
a transceiver that connects to a network and performs communication,
wherein the at least one program instruction is executed to obtain existing sales data of a store, comprising reservation history information and visit history information of customers by date of the store, from a database; preprocess the existing sales data of the store; generate a plurality of store demand forecasting models using a plurality of preset algorithms that have learned the preprocessed existing sales data of the store; determine a store demand forecasting model based on evaluation results of each of the store demand forecasting models; and forecast demand at the store using the determined store demand forecasting model.

9. The server according to claim 8, wherein the at least one program instruction is further executed to assign hyperparameters of each of the generated store demand forecasting models to each of the preset algorithms.

10. The server according to claim 8, wherein, when the at least one program instruction is executed to generate the store demand forecasting models, the at least one program instruction is executed to extract model establishment data from among the existing sales data of the store; generate, using the preset algorithms, models that have learned the model establishment data; and validate the models using validation data that is data excluding the model establishment data among the existing sales data.

11. The server according to claim 10, wherein, when the at least one program instruction is executed to generate the store demand forecasting models, the at least one program instruction is further executed to classify the existing sales data of the store according to a preset ratio based on label data of each of the existing sales data of the store, and
when the at least one program instruction is executed to extract model establishment data from among the existing sales data of the store, the model establishment data is extracted from among the existing sales data classified according to a preset ratio.

12. The server according to claim 8, wherein, when the at least one program instruction is executed to generate the store demand forecasting model, the at least one program instruction is further executed to input each of the reservation history information and the visit history information into a first artificial neural network; input the existing sales data of the store excluding the reservation history information and the visit history information into a second artificial neural network; and merge output values of the first artificial neural network and output values of the second artificial neural network,
wherein a store demand forecasting model is defined based on the merged output values of the first and second artificial neural networks.

13. The server according to claim 8, wherein the existing sales data of the store further comprise at least one of business type information of the store, size information of the store, and local information of the store.

14. The server according to claim 8, wherein the at least one program instruction is further executed to update the sales data of the store to the database; and examine suitability of the store demand forecasting model using the updated sales data of the store.
